(19) United States
(12) Patent Application Publication
(10) Pub. No.: US 2008/0252215 A1
(43) Pub. Date: Oct. 16, 2008

(54) PLASMA DISPLAY DEVICE

(75) Inventor: Ki-DONG KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/050,342

(22) Filed: Mar. 18, 2008

(30) Foreign Application Priority Data
Apr. 11, 2007 (KR) 10-2007-0035603

(51) Int. Cl. H01J 17/49

(52) U.S. Cl. 313/587

(57) ABSTRACT

A plasma display device includes: a plasma display panel including an address electrode disposed on a first substrate, a pair of first and second display electrodes disposed on a second substrate and crossing the address electrode, a dielectric layer covering the first and second display electrodes on the second substrate, an MgO protective layer covering the dielectric layer on the second substrate, and discharge gases filled between the first and second substrates; a driver that drives the plasma display panel; and a controller that controls a sustain pulse width of a sustain period to be 1 to 3.5 μs. The MgO protective layer includes 200 to 3000 ppm by weight of Ca based on the content of MgO. The plasma display device shows improved discharge stability and display quality due to reduced discharge delay time.

### CROSS-REFERENCE TO RELATED APPLICATIONS

This application claims the benefit of Korean Patent Application No. 2007-35603 filed Apr. 11, 2007, in the Korean Intellectual Property Office, the disclosure of which is incorporated herein by reference.

### BACKGROUND OF THE INVENTION

1. Field of the Invention

Aspects of the present invention relate to a plasma display device. More particularly, aspects of the present invention relate to a plasma display device that has improved discharge stability by reducing formative delay time.

2. Description of the Related Art

A plasma display panel is a display device that forms an image by exciting a phosphor layer with vacuum ultraviolet (VUV) rays generated by gas discharge in discharge cells.

A plasma display panel displays text and/or graphics by using light emitted from plasma that is generated by the gas discharge. An image is formed by applying a predetermined level of voltage to two electrodes situated in a discharge space of the plasma display panel to induce plasma discharge between the two electrodes and exciting a phosphor layer that is formed in a predetermined pattern by ultraviolet rays generated from the plasma discharge. (The two electrodes situated in the discharge space of the plasma display panel are hereinafter referred to as the “display electrodes.”)

Generally, the plasma display panel includes a dielectric layer that covers the two display electrodes and a protective layer on the dielectric layer to protect the dielectric layer. The protective layer is mainly composed of MgO which is transparent to allow visible light to permeate and which exhibits excellent protective performance for the dielectric layer and also produces secondary electron emission. Recently, however, alternatives and modifications to the MgO in the protective layer have been researched.

The MgO protective layer has a sputtering resistance characteristic that lessens the ionic impact of the discharge gas upon the discharge while the plasma display device is driven and protects the dielectric layer. Further, an MgO protective layer in the form of a transparent protective thin film reduces the discharge voltage through emitting of secondary electrons. Typically, the MgO protective layer is coated on the dielectric layer in a thickness of 5000 to 9000 Å.

Accordingly, the components and the membrane characteristics of the MgO protective layer significantly affect the discharge characteristics. The membrane characteristics of the MgO protective layer are significantly dependent upon the components and the coating conditions of deposition. It is desirable to develop optimal components for improving the membrane characteristics.

It is desirable to improve the discharge stability of the high-definition plasma display panel (PDP) through an improvement of the response speed. The high-definition plasma display panel should respond to a rapid scan speed such that a stable discharge in which all addressing is performed is established. The speed of the response to rapid scanning is determined by the formative delay time (Tf) and statistical delay time (Ts).

The above information disclosed in this Background section is only for enhancement of understanding of the background of the invention and therefore it may contain information that does not form the prior art that is already known in this country to a person of ordinary skill in the art.

### SUMMARY OF THE INVENTION

A plasma display device is provided that has improved discharge stability due to reduced formative delay time.

According to an embodiment of the present invention, there is provided a plasma display device that includes: a plasma display panel including an address electrode disposed on a first substrate, a pair of first and second display electrodes disposed on a second substrate and crossing the address electrode, a dielectric layer covering the first and second display electrodes on the second substrate, an MgO protective layer covering the dielectric layer on the second substrate, and discharge gases filled between the first and second substrates; a driver that drives the plasma display panel; and a controller that controls a sustain pulse width of a sustain period to be 1 to 3.5 μs. The MgO protective layer includes 200 to 3000 ppm of Ca based on MgO.

According to an aspect of the present invention, the MgO protective layer includes 200 to 3000 ppm of Ca based on MgO. According to a non-limiting example, the MgO protective layer includes 250 to 1500 ppm of Ca based on MgO.

According to a non-limiting example, the Ca in the MgO protective layer is present at a concentration gradient where the concentration of Ca increases from the surface of the MgO protective layer contacting the discharge gas to the other surface of the MgO protective layer.

According to a non-limiting example, the MgO protective layer includes MgO at more than or equal to 99.7 wt % based on the total weight of the MgO protective layer. According to another non-limiting example, the MgO protective layer includes MgO ranging from 99.7 to 99.9 wt % based on the total weight of the MgO protective layer.

The sustain pulse width is 1 to 3.5 μs. According to a non-limiting example, the sustain pulse width is 1 to 3.0 μs.

The sustain period is 9 to 25 μs. According to a non-limiting example, the sustain period may be 10 to 25 μs.

The first sustain pulse width of the sustain period is 2 to 7.5 μs. According to a non-limiting example, the first sustain pulse width of the sustain period ranges from 2 to 7 μs.

The discharge gas includes 5 to 30 parts by volume of Xe based on 100 parts by volume of Ne. According to a non-limiting example, the discharge gas further includes 0 to 70 parts by volume of at least one gas selected from the group of He, Ar, Kr, O₂, N₂, and combinations thereof based on 100 parts by volume of Ne.

According to another embodiment of the present invention, there is provided a plasma display panel comprising at least one pair of first and second display electrodes disposed on a substrate; a dielectric layer covering the at least one pair of first and second display electrodes; and an MgO protective layer covering the dielectric layer, the MgO protective layer including 200 to 3000 ppm by weight of Ca based on a content of MgO

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial exploded perspective view showing a structure of a plasma display panel according to an embodiment of the present invention;

FIG. 2 is a schematic view showing a plasma display device including the plasma display panel of FIG. 1;

FIG. 3 shows a driving waveform of the plasma display device of FIG. 2;

FIG. 4 is a graph showing a discharge delay time of the plasma display device according to Comparative Example 1 and Examples 1, 7, and 8; and

FIG. 5 is a graph showing a discharge delay time of the plasma display device according to Examples 2 to 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention relate to an MgO protective layer that covers a dielectric layer covering display electrodes of a plasma display panel and that can improve the discharge stability of the plasma display panel by reducing a formative delay time.

According to an embodiment of the present invention, a plasma display device is provided that includes: a plasma display panel including an address electrode disposed on a first substrate, a pair of first and second display electrodes disposed on a second substrate and crossing the address electrode, a dielectric layer covering the first and second display electrodes on the second substrate, an MgO protective layer covering the dielectric layer on the second substrate, and discharge gases filled between the first and second substrates; a driver that drives the plasma display panel; and a controller that controls a sustain pulse width of a sustain period to be 1 to 3.5 μs. The MgO protective layer includes 200 to 3000 ppm (by weight) of Ca based on the content of MgO.

Herein, in general, when it is mentioned that one layer or material is formed on or disposed on or covers a second layer or a second material, it is to be understood that the terms “formed on,” “disposed on” and “covering” are not limited to the one layer being formed directly on the second layer, but may include instances wherein there is an intervening layer or material between the one layer and the second layer.

The sustain pulse width is 1 to 3.5 μs. According to a non-limiting example, the sustain pulse width is 1 to 3.0 μs. When the sustain pulse width is 1 to 3.5 μs, the high-definition plasma display device has improved uniformity of images due to improved discharge stability.

The sustain period is 9 to 25 μs. According to a non-limiting example, the sustain period may be 10 to 25 μs. When the sustain period is 9 to 25 μs, the high-definition plasma display device has improved uniformity of images due to improved discharge stability.

The first sustain pulse width of the sustain period is 2 to 7.5 μs. According to a non-limiting example, the first sustain pulse width of the sustain period ranges from 2 to 7 μs. When the first sustain pulse width of the sustain period is 2 to 7.5 μs, the high-definition plasma display device has improved uniformity of images due to improved discharge stability.

The discharge gas includes 5 to 30 parts by volume of Xe based on 100 parts by volume of Ne. According to a non-limiting example, the discharge gas includes 7 to 25 parts by volume of Xe based on 100 parts by volume of Ne. When the discharge gas includes Xe and Ne within the above ratio, the discharge initiation voltage is decreased due to an increased ionization ratio of the discharge gas. When the discharge initiation voltage is decreased, the high-definition plasma display device has decreased power consumption and increased brightness.

According to a non-limiting example, the discharge gas may further include more than 0 to 70 parts by volume of at least one gas selected from the group consisting of He, Ar, Kr, O₂, N₂, and combinations thereof based on 100 parts by volume of Ne. According to a non-limiting example, the discharge gas includes 14 to 65 parts by volume of at least one gas selected from the group consisting of He, Ar, Kr, O₂, N₂, and combinations thereof based on 100 parts by volume of Ne. When the discharge gas includes at least one gas selected from the group consisting of He, Ar, Kr, O₂, N₂, and combinations thereof within the above ratio, the discharge initiation voltage is decreased due to an increased ionization ratio of the discharge gas. When the discharge initiation voltage is decreased, the high-definition plasma display device has decreased power consumption and increased brightness.

An embodiment of the present invention will hereinafter be described in detail with reference to the accompanying drawings. As those skilled in the art would realize, the described embodiments may be modified in various different ways, all without departing from the spirit or scope of the present invention.

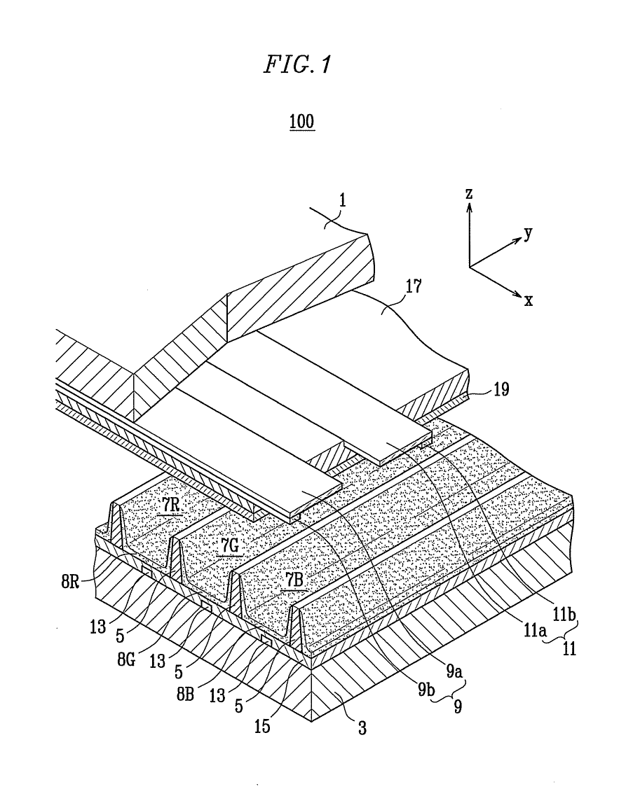

FIG. 1 is a partial exploded perspective view showing the structure of a plasma display panel according to one embodiment. Referring to the drawing, the PDP includes a first substrate 3, a plurality of address electrodes 13 disposed in one direction (the Y direction in the drawing) on the first substrate 3, and a first dielectric layer 15 disposed on the surface of the first substrate 3 covering the address electrodes 13. Barrier ribs 5 are formed on the first dielectric layer 15, and red (R), green (G), and blue (B) phosphor discharge cells 7R, 7G, and 7B are formed between the barrier ribs 5. Red (R), green (G), and blue (B) phosphor layers 8R, 8G, and 8B are disposed in the discharge cells 7R, 7G, and 7B.

The barrier ribs 5 may be formed in any shape as long as their shape can partition the discharge space, and the barrier ribs 5 may have diverse patterns. For example, the barrier ribs 5 may be formed as an open type, such as stripes, or as a closed type, such as a waffle, matrix, or delta shape. As further non-limiting examples, closed-type barrier ribs may be formed such that a horizontal cross-section of the discharge space is a polygon such as a quadrangle, triangle, or pentagon, or a circle or an oval.

Display electrodes 9 and 11, each including a pair of a transparent electrodes 9a or 11a and a bus electrode 9b or 11b, are disposed in a direction crossing the address electrodes 13 (the X direction in the drawing) on one surface of a second substrate 1 facing the first substrate 3. Also, a second dielectric layer 17 and an MgO protective layer 19 are disposed on the surface of the second substrate 1 while covering the display electrodes.

The MgO protective layer includes 200 to 3000 ppm of Ca based on the weight content of MgO. According to a non-limiting example, the MgO protective layer includes 250 to 1500 ppm of Ca by weight based on the content of MgO.

Discharge cells are formed at positions where the address electrodes 13 of the first substrate 3 are crossed by the display electrodes of the second substrate 1.

The discharge cells between the first substrate 3 and the second substrate 1 are filled with a discharge gas. As discussed above, the discharge gas includes 5 to 30 parts by volume of Xe based on 100 parts by volume of Ne. According to a non-limiting example, the discharge gas includes 7 to 25 parts by volume of Xe based on 100 parts by volume of Ne. The discharge gas further includes 0 to 70 parts by volume of at least one gas selected from the group consisting of He, Ar, Kr, O₂, N₂, and combinations thereof based on 100 parts by volume of Ne. According to a non-limiting example, the discharge gas includes 14 to 65 parts by volume of the gas based on 100 parts by volume of Ne.

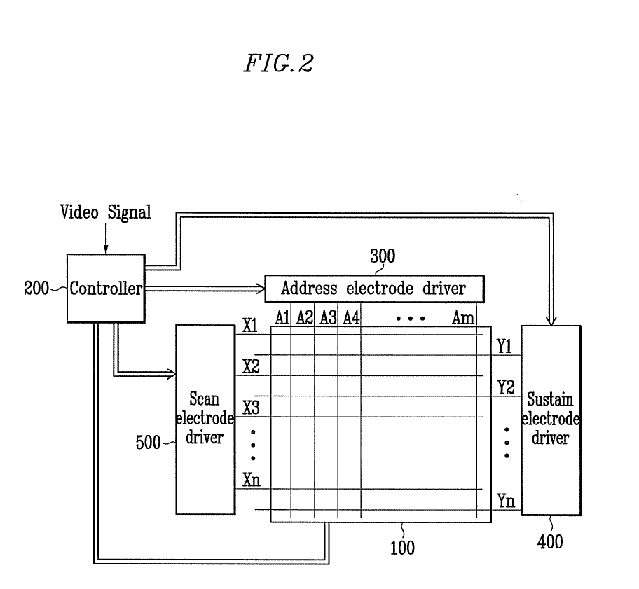

FIG. 2 is a schematic view showing a plasma display device according to an embodiment of the present invention. As shown in FIG. 2, the plasma display device according to one embodiment of the present invention includes a plasma display panel 100, a controller 200, an address electrode (A) driver 300, a sustain electrode (a second display electrode, X) driver 400, and a scan electrode (a first display electrode, Y) driver 500.

The plasma display panel 100 has the same structure as shown in FIG. 1.

The controller 200 receives video signals from the outside and outputs an address driving control signal, a sustain electrode (X) driving control signal, and a scan electrode (Y) driving control signal. The controller 200 divides one frame into a plurality of subfields, and each subfield is composed of a reset period, an address period, and a sustain period when the subfield is expressed based on temporal driving change.

The address driver 300 receives an address electrode (A) driving control signal from the controller 200, and applies a display data signal for selecting a discharge cell to be displayed to each address electrode.

A sustain electrode driver 400 receives a sustain electrode driving control signal from the controller 200, and applies a driving voltage to the sustain electrodes (X).

A scan electrode driver 500 receives a scan electrode driving control signal from the controller 200 and applies a driving voltage to the scan electrodes (Y).

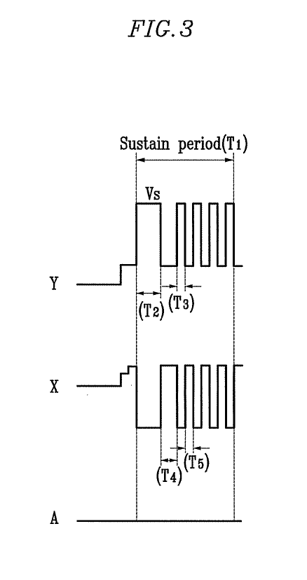

FIG. 3 shows a driving waveform of the plasma display device illustrated in FIG. 2. As shown in FIG. 3, the first sustain discharge pulse of the Vs voltage at the sustain period (T₁) is applied to the scan electrode (Y) and the sustain electrode (X), alternately. If the wall voltage between the scan electrode (Y) and the sustain electrode (X) is generated, the scan electrode (Y) and the sustain electrode (X) are discharged by the wall voltage and the Vs voltage. Then, the process to apply the scan electrode (Y) with the sustain discharge pulse of the Vs voltage and the process to apply the sustain discharge pulse of the Vs voltage to the sustain electrode (X) are repeated a number of times corresponding to the weighted value indicated by the subfield.

Herein, the first sustain pulse width (T₂) of the scan electrode (Y) or the first sustain discharge pulse width (T₄) of the sustain electrode (X) is 2 to 7.5 μs. According to a non-limiting example, the first sustain pulse width (T₂) of the scan electrode (Y) or the first sustain discharge pulse width (T₄) of the sustain electrode (X) ranges from 2 to 7 μs. The sustain discharge pulse width (T₃) of the scan electrode (Y) or the sustain discharge pulse width (T₅) of the sustain electrode (X) is 1 to 3.5 μs. According to a non-limiting example, the sustain discharge pulse width (T₃) of the scan electrode (Y) or the sustain discharge pulse width (T₅) of the sustain electrode (X) ranges from 1 to 3.0 μs. The sustain period (T₁) is 9 to 25 μs. According to a non-limiting example, the sustain period (T₁) ranges from 10 to 25 μs.

According to one embodiment, the plasma display panel is driven by the driving waveform, and includes the discharge gas filled therein and the MgO protective layer prepared using an MgO sintered material doped with Ca. The plasma display panel has improved driving stability, discharge characteristics, and display quality. The MgO protective layer includes 200 to 3000 ppm by weight of Ca based on the content of MgO. According to a non-limiting example, the MgO protective layer includes 250 to 1500 ppm by weight of Ca based on the content of MgO.

When the Ca content is within the range, the statistical delay time can be reduced. When the Ca content is less than 200 ppm, the improved effects are not sufficient. When the Ca content is more than 3000 ppm, the discharge delay time increases.

According to one embodiment, the Ca of the MgO protective layer is present in a concentration gradient in which the concentration of Ca increases from the surface of the MgO protective layer contacting the discharge gas to the surface of the MgO protective layer contacting the dielectric layer covering the display electrodes. When the Ca of the MgO protective layer is present in a concentration gradient, the discharge stability is improved by reducing the loss of secondary electron emission by MgO. Additionally, since the Ca content is not reduced in the entire MgO protective layer although the Ca content is reduced at the surface of the MgO protective layer, the life-span of plasma display device is not deteriorated.

According to a non-limiting example, the MgO protective layer includes MgO in an amount greater than or equal to 99.7 wt % based on the total weight of the MgO protective layer. According to another non-limiting example, the MgO protective layer includes MgO ranging from 99.7 to 99.9 wt % based on the total weight of the MgO protective layer. When the MgO content is more than 99.7 wt %, the formative delay time is sharply reduced by reducing the contents of impurities except Ca and increasing the purity of MgO in the MgO protective layer.

The method of fabricating the plasma display device is well known to persons skilled in this art, so a detailed description thereof will be omitted from this specification. The process for forming the MgO protective layer according to one embodiment of the present invention will now be described.

The MgO protective layer covers the surface of the dielectric layer covering the display electrodes in the plasma display device to protect the dielectric layer from ionic impact of the discharge gas during the discharge. The MgO protective layer is mainly composed of MgO having sputtering-resistance and a high secondary electron emission coefficient.

The MgO material may include a monocrystalline or sintered material. In a case of a MgO monocrystalline material, it is difficult to determine a fixed quantity of a particular doping element due to a difference between solid solution limits since the cooling rate is different upon melting for the deposition.

According to one embodiment of the present invention, a certain quantity of Ca as a doping element is added during the preparation of a sintered MgO material. The content of Ca added in the MgO material is controlled that the Ca content in the MgO protective layer ranges from 200 to 3000 ppm, or, as a non-limiting example, from 250 to 1500 ppm.

The protective layer may be formed by a thick-film printing method utilizing a paste. However, a layer formed by the thick-film printing method has relative disadvantages in that the printed layer is weak against sputtering by ion bombardment, and cannot reduce a discharge sustain voltage and a discharge firing voltage by secondary electron emission. Therefore, the protective layer is preferably formed by physical vapor deposition.

The method of forming the MgO protective layer by the physical vapor deposition is preferably a plasma deposition method. Plasma deposition methods include methods using electron beams, deposition beams, ion plating, or magnetron sputtering.

Further, since the MgO protective layer is contacted with the discharge gas, the components and the membrane characteristics thereof significantly affect the discharge characteristics. The MgO protective layer characteristic is significantly dependent upon the components and the coating conditions during deposition. The components should be chosen to meet requirements of the coating conditions.

The following examples illustrate the present invention in more detail. However, it is understood that the present invention is not limited by these examples.

Manufacture of a Plasma Display Device

### COMPARATIVE EXAMPLE 1

Display electrodes having a stripe shape were formed on a soda lime glass substrate in accordance with a conventional process.

A glass paste was coated on the substrate formed with the display electrodes and fired to provide a second dielectric layer.

An MgO protective layer including 3300 ppm by weight of Ca based on the content of MgO was formed on the second dielectric layer by ion plating to fabricate a second substrate. The MgO protective layer included 99.7 wt % of MgO based on the total weight of the MgO protective layer. A plasma display device was manufactured using the fabricated second substrate.

### EXAMPLE 1

A plasma display device was manufactured according to the same method as in Comparative Example 1, except that an MgO protective layer including 250 ppm by weight of Ca based on the content of MgO and 99.9 wt % of MgO based on the total weight of the MgO protective layer was used. The sustain pulse width of a sustain period was 2.1 μs, the sustain period was 15 μs, and the first sustain pulse width of the sustain period was 2.1 μs. Also, the discharge gas included 11 parts by volume of Xe and 35 parts by volume of He based on 100 parts by volume of Ne.

### EXAMPLE 2

A plasma display device was manufactured according to the same method as in Comparative Example 1, except that an MgO protective layer including 2500 ppm by weight of Ca based on the content of MgO and 99.9 wt % of MgO based on the total weight of the MgO protective layer was used.

### EXAMPLE 3

A plasma display device was manufactured according to the same method as in Comparative Example 1, except that an MgO protective layer including 350 ppm by weight of Ca based on the content of MgO and 99.9 wt % of MgO based on the total weight of the MgO protective layer was used.

### EXAMPLE 4

A plasma display device was manufactured according to the same method as in Comparative Example 1, except that an MgO protective layer including 1500 ppm by weight of Ca based on the content of MgO and 99.9 wt % of MgO based on the total weight of the MgO protective layer was used.

### EXAMPLE 5

A plasma display device was manufactured according to the same method as in Comparative Example 1, except that an MgO protective layer including 700 ppm by weight of Ca based on the content of MgO and 99.9 wt % of MgO based on the total weight of the MgO protective layer was used.

### EXAMPLE 6

A plasma display device was manufactured according to the same method as in Comparative Example 1, except that an MgO protective layer including 3000 ppm by weight of Ca based on the content of MgO and 99.9 wt % of MgO based on the total weight of the MgO protective layer was used.

### EXAMPLE 7

A plasma display device was manufactured according to the same method as in Comparative Example 1, except that an MgO protective layer including 250 ppm by weight of Ca based on the content of MgO and 99.7 wt % of MgO based on the total weight of the MgO protective layer was used.

### EXAMPLE 8

A plasma display device was manufactured according to the same method as in Comparative Example 1, except that an MgO protective layer including 250 ppm by weight of Ca based on the content of MgO and 99.5 wt % of MgO based on the total weight of the MgO protective layer was used.

Measurement of Discharge Delay Time of the Plasma Display Device

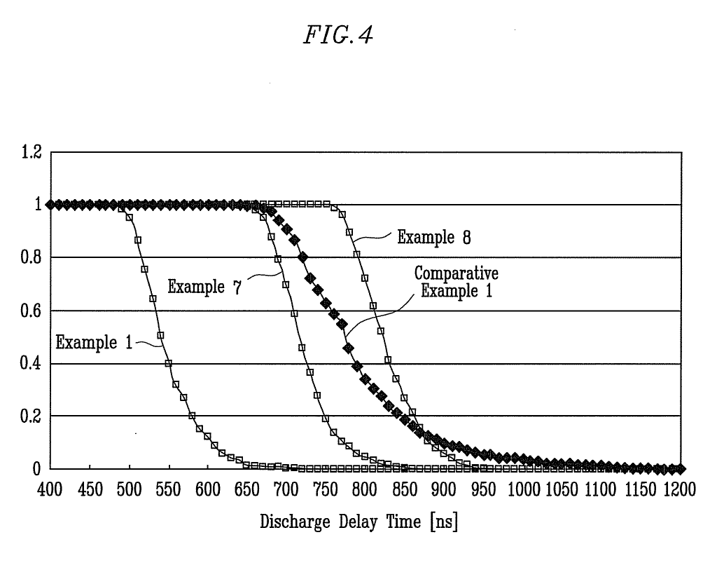

Discharge delay times of the plasma display devices according to Comparative Example 1 and Examples 1 to 8 were measured. The measurement results for Comparative Example 1 and Examples 1, 7, and 8 are shown in FIG. 4.

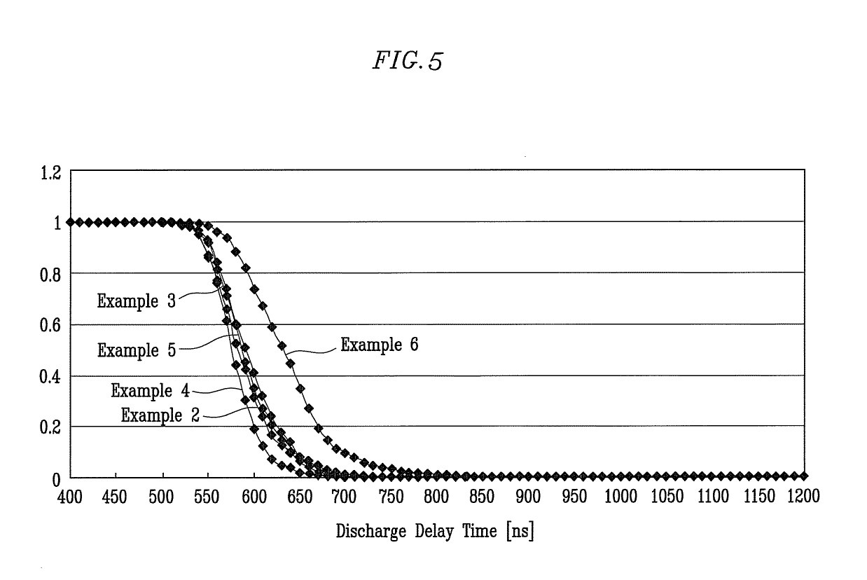

Further, the measurement results for Examples 2 to 6 are shown in FIG. 5.

As shown in FIG. 4, the statistical delay time of the plasma display device according to Examples 1, 7, and 8 is shorter than that of the plasma display device according to Comparative Example 1. Additionally, the formative delay time of the plasma display device according to Example 1 is shorter than those of the plasma display devices according to Examples 7 and 8.

As shown in FIG. 5, when the MgO protective layer includes Ca in amounts of 350, 700, 1500, 2500, and 3000 ppm respectively, the statistical delay time is changed.

As described above, a plasma display device in which a sustain pulse width of a sustain period is 1 to 3.5 μs, a sustain period is 9 to 25 μs, and a discharge gas includes 5 to 30 parts by volume of Xe based on 100 parts by volume of Ne has improved discharge stability when an MgO protective layer formed on the dielectric layer covering the display electrodes includes 200 to 3000 ppm of Ca.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel including
at least one pair of first and second display electrodes disposed on a substrate;
a dielectric layer covering the at least one pair of first and second display electrodes; and
an MgO protective layer covering the dielectric layer;
a driver that drives the plasma display panel; and
a controller that controls a sustain pulse width of a sustain period to 1 to 3.5 μs,
wherein the MgO protective layer includes 200 to 3000 ppm by weight of Ca based on a content of MgO.

2. The plasma display device of claim 1, wherein the MgO protective layer comprises 250 to 1500 ppm by weight of Ca based on the content of MgO.

3. The plasma display device of claim 1, wherein the Ca in the MgO protective layer is present at a concentration gradient where the concentration of Ca increases from a first surface of the MgO protective layer exposed to the discharge gas to a second surface of the MgO protective layer contacting the dielectric layer.

4. The plasma display device of claim 1, wherein the MgO protective layer comprises MgO at more than or equal to 99.7 wt % based on the total weight of the MgO protective layer.

5. The plasma display device of claim 4, wherein the MgO protective layer comprises MgO ranging from 99.7 to 99.9 wt % based on the total weight of the MgO protective layer.

6. The plasma display device of claim 1, wherein the sustain pulse width is 1 to 3.0 μs.

7. The plasma display device of claim 1, wherein the sustain period ranges from 9 to 25 μs.

8. The plasma display device of claim 7, wherein the sustain period ranges from 10 to 25 μs.

9. The plasma display device of claim 1, wherein the first sustain pulse width of the sustain period is 2 to 7.5 μs.

10. The plasma display device of claim 9, wherein the first sustain pulse width of the sustain period is 2 to 7 μs.

11. The plasma display device of claim 1, wherein the plasma display panel further comprises a discharge gas including 5 to 30 parts by volume of Xe based on 100 parts by volume of Ne.

12. The plasma display device of claim 11, wherein the discharge gas further comprises 0 to 70 parts by volume of at least one gas selected from the group consisting of He, Ar, Kr, O₂, N₂, and combinations thereof based on 100 parts by volume of Ne.
